(19) United States
(12) Patent Application Publication
(10) Pub. No.: US 2006/0015817 A1
(43) Pub. Date: Jan. 19, 2006

(54) Method to dynamically customize a web user interface

(76) Inventors: Giuseppe Fioretti, Roma (IT); Massimiliano Bevilacqua, Foligno (IT)

Correspondence Address: IBM CORPORATION;INTELLECTUAL PROPERTY LAW, 11400 BURNET ROAD, AUSTIN, TX, 78758, US

(21) Appl. No.: 11/168,721

(22) Filed: Jun. 28, 2005

(30) Foreign Application Priority Data
Jul. 15, 2004 (FR) 04368050.3

(51) Int. Cl. G06F 3/00

(52) U.S. Cl. 715/765

(57) ABSTRACT

A method, computer program and data processing system for customizing the visualization of a Web page on a client side of a Web application operating on a computer, the server side of the Web application being responsible for receiving parameters entered by a user on the client side, processing them and sending back a new Web page wherein, if at least one visualization parameter is received among the parameters, it is reapplied in the new Web page. The method comprises the steps of storing the customization parameters entered by a user on a currently displayed Web page on the client side and locally applying them on the Web page. When a page form is sent with parameters entered by the user and which are relevant for the Web application, adding the stored current customization parameters with the other parameters. The new Web page generated by the server side of the Web page application and sent to the client side will contain the visualization customization parameters entered by the user.

### FIELD OF THE INVENTION

The present invention relates generally to the field of client server applications including a Web user interface; more particularly, the invention applies to customization of Web pages of the Web user interface during the execution of the application.

### BACKGROUND OF THE INVENTION

As a common practice, each time a user enters on the client side a new data on a Web page made available by the server application, the data is sent through the network from the client application to the server application for further processing. The data sent by the client is received by the server, the entered data is analyzed and, if the data which was entered is relevant for the prosecution of the application, the corresponding process occurs and the server sends back a new Web page corresponding to the next step in the application process. The exchange of information between the server and the client generates some traffic through the network and impacts the transaction response time from the user perspective.

Among the Web pages which are transferred between the client and server application and which create traffic, some pages are for customization of a Web page of the application. What is called ‘customization of a Web page’ means the customization of the visualization of that page. The user may have the possibility when executing the client side application to enter the ‘user preferences’ to customize a Web page of the application interface. For instance the user may be requested to choose which icon he wants to have permanently displayed or, the user may be requested to expand or collapse the view of a structure etc . . . The customization chosen by the user must be maintained for the duration of execution by the user of a task on one or more Web pages or the user may decide, at any time during the execution of the task, to change this customization and enter a new customization.

In the normal process the server side application applies and maintain the customization on the Web pages it sends to the client side application. When a user enters a customization parameter as a new data, the form of the page containing the data entered is sent to the server, the server analyzes that the new data entered is a customization parameter, it does not execute a process corresponding to a new data, it stores the customization parameters, applies them to the same Web page and sends the customized Web page to the client. In the execution of the step of storing customization parameters, the server may replace customization parameters previously stored according to a previous customization performed by the user. When the user enters a new data relevant for the application, the modified Web page form is sent from the client to the server. The server analyzes that the data is not for customization but is relevant to the application, executes the process corresponding to the new data, prepares a new Web page corresponding to the next step in the application and applies the already stored customization parameters on the Web page before sending it to the client.

In the process of entering customization parameters, each time a user enters a customization parameter, an exchange of data is performed between the client and the server. During this customization, these data transfer significantly decreases time requested to complete a task. The customization operations slow down the execution of tasks, it has a very bad impact on the usability of the entire application.

To overcome this problem, one option is, from the client side, to enter all the customization parameters and to send them all at the same time in one Web page. The drawback of this solution is that if the user wants to change one parameter, he has to stop the task, go back to the Web page for entering the customization parameters and re-send the customization data to the server. This solution saves the initial problem of limiting the traffic due to customization page transfer but looses in usability.

One other option is suggested in the international patent application under the PCT whom the international publication number is WO 2004/023236. It consists, in order to solve the same problem of reducing the traffic between the client and the server, to duplicate on a local storage medium a thin server application and a thin database. This duplicated application implies available local storage and a maintenance activity on the code. This solution is very costly to implement, a ‘lighter’ solution would be preferable.

There is a need for minimizing response time of the user interacting with Web pages for customization on the client side of a client-server application having a Web user interface while maintaining a good level of usability.

### SUMMARY OF THE INVENTION

It is therefore a main object of the invention to provide a method for minimizing response time when the user customizes the application through Web pages from the client side of a client-server application providing a Web user interface.

A further object to maintain a good usability from a user perspective.

These objects are achieved with the method of claim 1 for customizing the visualization of a Web page on a client side of a Web application operating on a computer, the server side of the Web application being responsible for receiving parameters entered by a user on the client side, processing them and sending back a new Web page wherein, if at least one visualization parameter is received among the parameters, it is reapplied in the new Web page, said method comprising the steps of:
receiving, on the client side of the Web application, from the user, at least one visualization customization parameter entered on a displayed Web page;
storing the at least one visualization customization parameter;
creating the Web page source modifications corresponding to the at least one visualization customization parameter;
displaying the modified Web page;
upon reception from the user of at least one parameter entered on the displayed Web page which is not a visualization customization parameter but at least one parameter relevant for the Web application, retrieving the stored at least one visualization customization parameter;
sending to the server side Web application the at least one parameter relevant for the application and the at least one visualization customization parameter; and,
receiving from the server side a new Web page according to the processing of the server side Web application, said new Web page including Web page source modifications corresponding to the at least one visualization customization parameter.

The objects of the invention are also achieved with the method of claim 2 which is the method of claim 1 further comprising the step of displaying the new Web page with the at least one customization parameters.

The objects of the invention are also achieved with the method of claim 3 which is the method of claim 1 or 2 wherein the displaying of a Web page and the step of sending and receiving a Web page is done by calling a Web browser operating on the client side.

The objects of the invention are also achieved with the method of claim 3 which is the method of anyone of claim 1 to 3 wherein the visualization customization parameters are layout parameters.

The objects of the invention are also achieved with a computer program product comprising programming code instructions for executing the steps of the method according to anyone of claims 1 to 4 when said program is executed on a computer.

The objects of the invention are also achieved with a data processing system comprising means adapted for carrying out the method according to anyone of claims 1 to 4.

A further advantage of the solution of the invention is that it is a ‘light’ solution, simple to implement on the client side. Also, any kind of high level interpreted programming language understandable by the browser at the client side can be used. Programming in Java, for instance, would have required Java package installation on the client side. With Javascript, chosen in the preferred embodiment, this high level interpreted language is understood by all the browsers and as a high level language it does not require further compiler installation.

One other advantage of the solution compared to a solution with cookies is that this solution with Javascript is much more secure. Some users manipulate cookies and suppress accessibility of cookies by the browser, in which case the invention cannot be used from the client side.

### BRIEF DESCRIPTION OF THE DRAWINGS

FIG. 1 exemplifies some customizations that could be done in a Web page;

FIG. 2 describes the computing environment for execution of the method of the preferred embodiment;

FIG. 3 describes the logical block of the implementation of the method in the client side according to the preferred embodiment;

FIG. 4 illustrates the client server application interactions according to the method of the preferred embodiment;

FIG. 5 shows the flowchart of the method as executing on the client side for customizing a page according to the preferred embodiment;

FIG. 6 shows the flowchart of the method as executing on the client side for sending a page to the server according to the preferred embodiment;

FIG. 7 is the flowchart of the method as executing on the server side.

### DETAILED DESCRIPTION OF THE PREFERRED EMBODIMENT

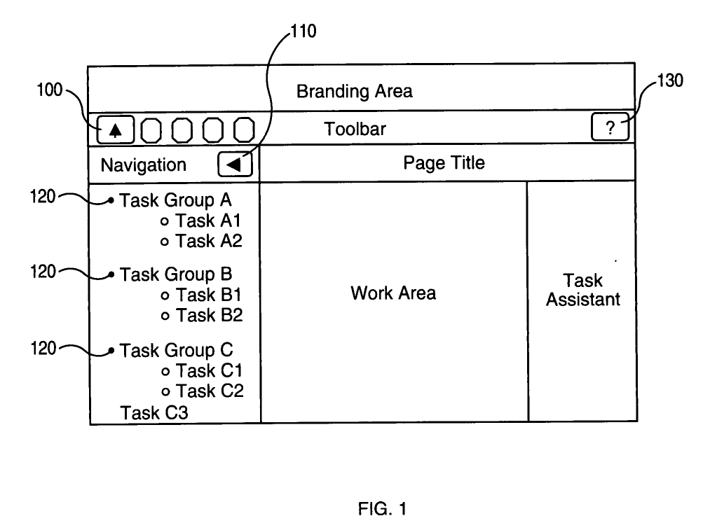

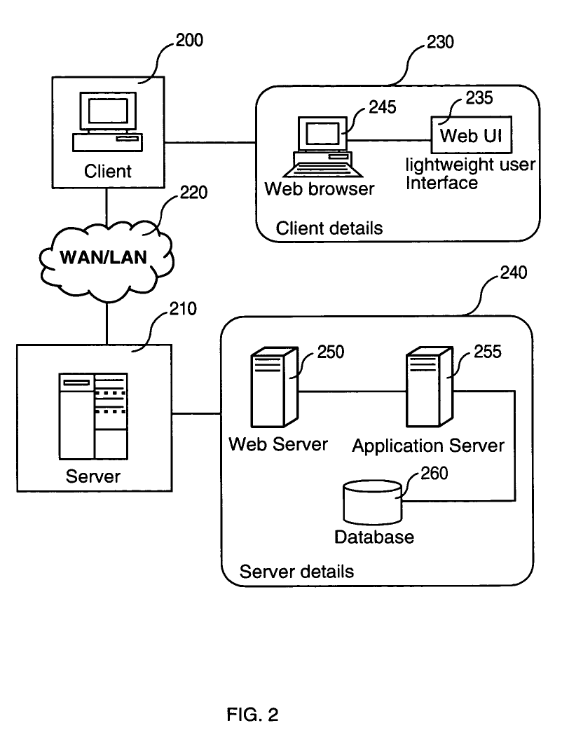

The picture in FIG. 1 exemplifies some customizations that could be done in a web page of the Web user interface of a client server application. On the client side, the user can choose a presentation of his application. For instance, in the screen view representing a Web page of FIG. 1, four customizations are possible. The toolbar with the different icon representing specific functions of the application can be either shown or hidden (100). In the screen view representation of FIG. 1 the user has chosen to show the toolbar. This means that user intends to use the functions for a period of time. A second customization represented in FIG. 1 is the Web navigation which can be either hidden or shown. In the example of FIG. 2 the Web navigation (110) has been chosen to be shown. Similarly in this example the user has chosen to expand the display of Task Groups (120) for Task Groups A, B and C. The user, later in the execution of the application may require to collapse the Task Group display because he no more need to work with the Tasks. The last customization illustrated in FIG. 1 is the Task assistant which can be either hidden or shown. In this example the user has chosen to display the task assistant. The user may need contextual help during the execution of his application for a period of time.

FIG. 2 describes the computing environment for execution of the method of the preferred embodiment. The method is particularly useful in any environment of the client-server type, where network time latencies, server and database processing times play a critical role. A typical environment where the invention can be applied is usually made of a client-server environment, where the client (200) needs to communicate with the server (210) using a WAN/LAN (220) as communication link. An application is intended to run on the server side and the client needs to access and use the application for its business purposes.

Details are provided in the expansion (230, 240) of the client and server side environment. The client side (230) usually provides some means to navigate the application, such as a lightweight user interface (235) running on a web browser (245), while the server side (240) usually provides the application logic and the business data.

A typical application flow starts from the client side, where a command can be issued using the user interface running on the web browser. The part played by the Web browser is only to display the Web pages. On the server side, the web server (250) detects an incoming request and forwards it to the application server (255), which executes the necessary business logic, usually accessing a database (260) that can be either local or remote. The generated response (HTML, XML) is finally returned to the requesting client. From the application flow, it is clear that the time to obtain a response from a client perspective strongly depends on the following issues: delays due to the communication link (220), processing times on web server application server and database server (250, 255, 260).

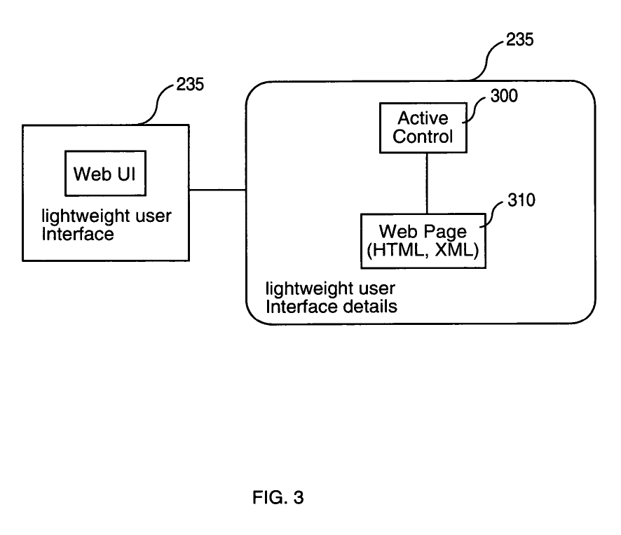

If the solution of the preferred embodiment is applied to this environment, these delays are minimized avoiding unnecessary requests towards the server side that can be elaborated on the client side. The unecessary requests which are avoided are the exchange of all the pages, a page form from the client to the server and an entire Web page from the server to the client, used during the customization. According to the preferred embodiment the lightweight user interface (235) has further capabilities than the simple Web page navigation, asking the browser to display locally the current Web page of the application. The lightweight user interface has an active control and caching capabilities as described in reference to FIG. 3.

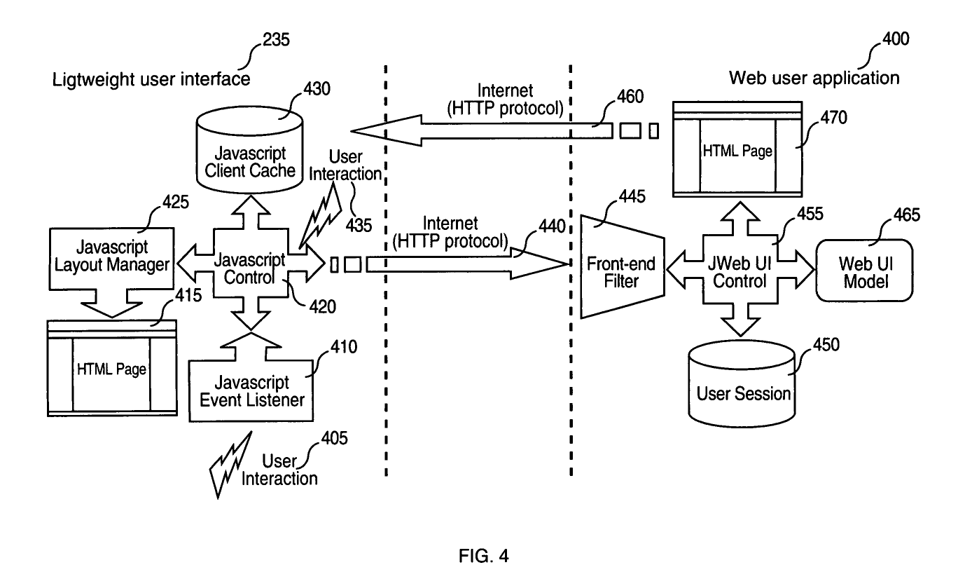

FIG. 3 describes the logical block of the implementation of the method in the client side according to the preferred embodiment. The solution of the preferred embodiment is implemented in the client side, in the Lightweight user interface (235). As with the prior art, the browser runs in the client side and display the Web pages (310). With the solution of the preferred embodiment, the user can manipulate some page controls such as the task assistant or help through a new block, the active control (300) without sending requests to the server side. The active control will store the user settings and will provide the necessary update of the stored settings only when the user submits any data to the server which is relevant for the prosecution of the application. The active control logical block is described in further details in reference to FIG. 4.

FIG. 4 illustrates the client server application interactions according to the method of the preferred embodiment. In FIG. 4 are illustrated the logical blocks implementing the solution of the preferred embodiment in the client Web user interface so called here the Lightweight user interface. In FIG. 4 are also illustrated the interactions between the user and the Lightweight user interface, as well as the interactions between the user application in the server which is the front-end of the server Web application and the Lighweight user interface. In FIG. 4 is also illustrated the programming blocks (410, 420, 430, 425) forming the active control (300, FIG. 3) of the Lightweight user interface according to the preferred embodiment. In FIG. 4 the programming blocks (445, 455, 450, 465) forming the Web user application in the server and all the interactions between these programming blocks are described.

Among the visualization customization parameters of a Web page some are related to the localization of the objects on the Web page. They are so called the layout parameters. Other visualization customization parameters are the ‘look and feel’ parameters such as the color of characters. The example of FIG. 4 is for supporting the customization of layout parameters. The same preferred embodiment applies to the other type of parameters.

From the client side, the Web user interface is the Lightweight user interface (235). According to the preferred embodiment, the Lightweight user interface, is responsible for detecting the events triggered by the user (405) acting with his/her mouse or through the keyboard within the browser screen, responding to them in real time mode to modify the current page layout. This function of modifying the current page layout is done by the server in the prior art. The Lightweight user interface also caches the customization parameters entered by the user during the customization and finally gives the cached user preferences to the browser to have them sent to the server when the user submits the main form of the page (440).

The user application (400), which is not changed with the solution of the preferred embodiment, comprises a Front-end filter (445) which filters the customization parameters by analyzing the page layout status of the Web page which has been received. The server Web user interface stores the customization parameters with the user session information (450). The user session information is a container of parameters that the server maintains; these parameters concern the user that is currently using the Web application. Then, when a new page is to be built according to the process of data received, the user application retrieves the current page layout status from the user session and finally builds and sends to the client browser (460) the new page reflecting the up to date customization parameters.

Javascript is chosen as the programming language in the preferred embodiment. The exchanges between the Javascript programming blocks of the client Lightweight user interface and the server Web user interface are as follows:

1. The user customizes the interface by changing some page layout preferences (405)

2. The Javascript Event Listener (410) detects the events and invokes the Javascript Control (420)

3. The Javascript Control (420) executes two actions:

stores the parameters that describe the new page Layout status into the Javascript Client Cache (430)

provides the new page layout parameters corresponding to the user preferences to the Javascript Layout Manager, which modifies the page layout by mean of dynamically changing the HTML source

4. Later on, the user submits (435) the main form of the page that is the form containing the relevant input parameters to be processed by the server application.

5. The Javascript Control retrieves the page layout status from the Javascript Client Cache and writes them in the page form as hidden parameters before the form is given to the browser.

6. The browser sends the page with the page layout status parameters together with all the other parameters submitted by the user through the HTTP connection to the server (440)

7. The server front-end filters (445) the page layout status parameters and stores them into the user session (450) for a further retrieval

8. When the Web UI model (465) containing the data responding to the user's request is triggered by the server application to prepare a new page, the Web UI Control (455) starts building the new page to be sent to the client browser

9. When the new page layout must be set, the Web UI Control (455) gets the page layout status from the user session database, completes the new page (470) and sends it to the browser through the HTTP connection (460)

10. The browser reads the HTML source and displays the new page with the up to date layout.

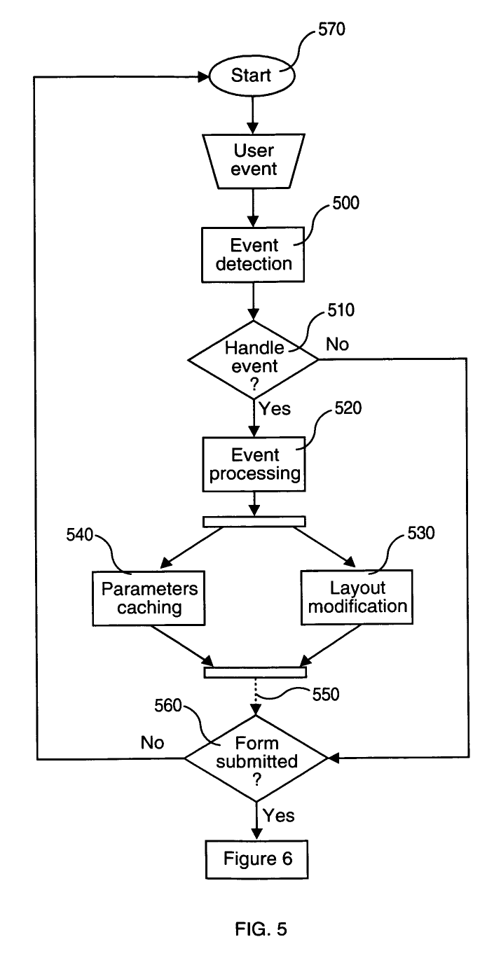

FIG. 5 shows the flowchart of the method as executing on the client side for page customization according to the preferred embodiment;

Every time the Javascript Event Listener detects (500) a user event that is to be handled by the active Javascript Control (answer Yes to test 510), it provides (520) to the active Javascript Control a key-value pair with the id of the event and a value identifying the requested status for the active object of the page. A user event is handled by the active Javascript Control only if the status of the active object has effectively changed (test 510).

At this point in time the active Javascript Control must perform two flows of actions:

1. Delegates the Javascript Layout Manager to modify (530) dynamically the page layout according to the information conveyed by the key-value pair.

2. Push into the cache (540), represented by a map, the new value for the event id.

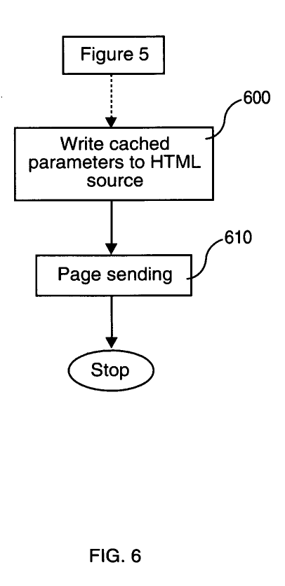

The Javascript Listener then waits (550) for a further event. If the user enters relevant data for the server application the corresponding Web page (more exactly, a page form, as only the content and not the page presentation is sent, on the contrary in the direction server-to-client the entire Web page is always sent) is submitted to the browser for being sent to the server. In this case (answer Yes to test 560) the process goes on in FIG. 6. If no page is submitted (answer No to test 560), the Javascript Control waits for a further event (570).

FIG. 6 shows the flowchart of the method as executing on the client side for sending a page to the server according to the preferred embodiment.

When the form is submitted, the active Javascript Control is notified by the Javascript Event Listener of the submission event, and begins copying the page layout status parameters from the cache map to the HTML source of the current page (600). Going into details, every key-value pair is popped by the active Javascript Control from the map and written to the HTML form as hidden parameter. When this process is completed, the flow control returns to the browser, which sends to the server, through the HTTP connection, all the parameters of the web page, comprised of the page layout hidden parameters (610).

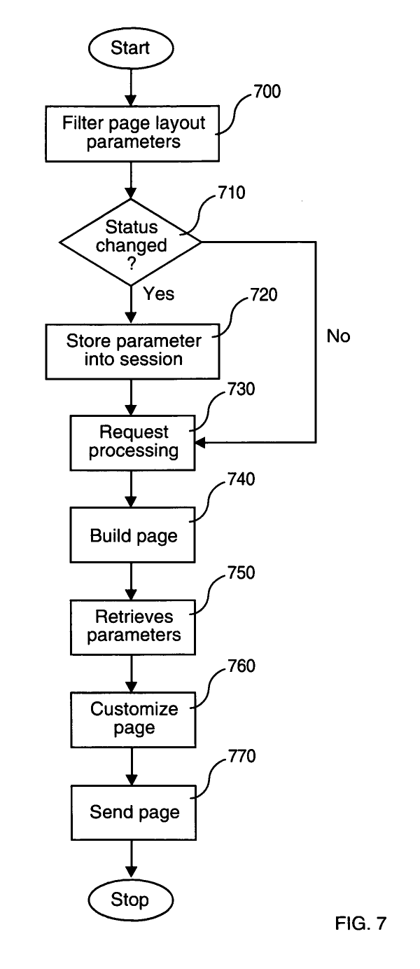

FIG. 7 is the flowchart of the method as executing on the server side. The same method applies in the prior art and according to the preferred embodiment. When the server front-end receives the browser request with the web page parameters, it filters the parameters (700), compares the ones related to the page layout status with the ones already stored in the user session (710) and, if needed (answer Yes to test 710), replace them (720) in the user session database. Then the Web UI Control starts doing all the processing needed to respond to the browser request (730), for instance, invokes the application logic which accesses a local or remote database. Once the data model is completed with all the requested data, the Web UI Control starts building the new page (740), filling it with the business data retrieved from the data model. At this point in time the Web UI Control retrieves the page layout status parameters from the user session (750) and is able to set the page layout according to the latest user preferences (760). Finally, the web page is sent to the browser (770).

In the preferred embodiment the HTTP protocol has been chosen for communication between client and server over the network. Any other communication protocol adapted for client server exchanges could be used as well. It is noted that the preferred embodiment applies to client server applications having Web user interface and user application (more particularly the Front-end filter programming block) sharing a common dictionary in order to understand the passed and received parameters.

The active control block on the client side is a Javascript, in the preferred embodiment, running on the client web browser. An applet could work the same, but it is much heavier and has longer download times. Because of time and performance preferred embodiment applies to client server applications having Web user interface and user application (more particularly the Front-end filter programming block) sharing a common dictionary in order to understand the passed and received parameters.

The active control block on the client side is a Javascript, in the preferred embodiment, running on the client web browser. An applet could work the same, but it is much heavier and has longer download times. Because of time and performance constraints the applet solution has not been considered in the preferred embodiment.

The method of the preferred embodiment is applied to a client environment comprising a user interfacing the client application and entering data related to the customization of the Web page or business data on the Web page. The entries to a Web page can be done also via a programming interface and in this environment also, the Web user interface of the Application can take benefit of the invention.

1. A method for customizing the visualization of a Web page on a client side of a Web application operating on a computer, the server side of the Web application being responsible for receiving parameters entered by a user on the client side, processing them and sending back a new Web page wherein, if at least one visualization parameter is received among the parameters, it is reapplied in the new Web page, said method comprising the steps of:
receiving, on the client side of the Web application, from the user, at least one visualization customization parameter entered on a displayed Web page;
storing the at least one visualization customization parameter;
creating the Web page source modifications corresponding to the at least one visualization customization parameter;
displaying the modified Web page;
upon reception from the user of at least one parameter entered on the displayed Web page which is not a visualization customization parameter but at least one parameter relevant for the Web application, retrieving the stored at least one visualization customization parameter;
sending to the server side Web application the at least one parameter relevant for the application and the at least one visualization customization parameter; and,
receiving from the server side a new Web page according to the processing of the server side Web application, said new Web page including Web page source modifications corresponding to the at least one visualization customization parameter.

2. The method of claim 1 further comprising the step of displaying the new Web page with the at least one customization parameters.

3. The method of anyone of claim 1 wherein the displaying of a Web page and the step of sending and receiving a Web page is done by calling a Web browser operating on the client side.

4. The method of anyone of claim 1 wherein the visualization customization parameters are layout parameters.

5. A computer program product comprising programming code instructions for executing the steps of the method according to anyone of claims 1 when said program is executed on a computer.

6. A data processing system comprising means adapted for carrying out the method according to anyone of claims 1.
